(19) United States
(12) Patent Application Publication
(10) Pub. No.: US 2016/0255403 A1
(43) Pub. Date: Sep. 1, 2016

(54) INTEGRATED USER INTERFACE FOR ACCESS TO LINEAR AND NON-LINEAR MULTIMEDIA CONTENT FROM MULTIPLE SOURCES, AND METHOD FOR IMPLEMENTING THE SAME

(71) Applicant: TQTVD SOFTWARE LTDA, Rio de Janeiro - RJ (BR)

(72) Inventors: Marcelo Amaral Gomes, Rio de Janeiro (BR); Helder Ribeiro Dos Santos, Niteroi (BR); Herman Rafael Perrone, Rio de Janeiro (BR); David Estevam De Britto, Niteroi (BR)

(21) Appl. No.: 14/766,428

(22) PCT Filed: Jan. 24, 2014
(86) PCT No.: PCT/BR2014/000033

§ 371 Date: Apr. 4, 2016

(30) Foreign Application Priority Data
Feb. 8, 2013 (BR) BR1020130031879

(51) Int. Cl. H04N 21/472; H04N 21/454; H04N 21/44; H04N 21/443; H04N 21/61; H04N 21/438; H04N 21/482

(52) U.S. Cl. CPC H04N 21/47202; H04N 21/4383; H04N 21/454; H04N 21/4828; H04N 21/4435; H04N 21/6125; H04N 21/44016

(57) ABSTRACT

The present invention relates to a digital TV receptor system comprising a user interface for integrated access to linear multimedia content such as, for example, digital TV channels transmitted by land, satellite or cable TV broadcasters, “multi-cast” or live streams transmitted by data networks or over the Internet, as well as on demand or non-linear multimedia content, such as, for example, contents of Internet services and/or multimedia applications in a digital TV reception apparatus having support for playback of such multimedia content, allowing the user to navigate through linear and non-linear content in a single list and in a transparent manner, in such a way as to present non-linear content as if such content were also TV channels. The user interface comprises a digitally readable medium comprising lines of program code and means for running such lines of program code in order to implement integrated access to linear and non-linear multimedia content from multiple sources in a digital TV reception apparatus.

### FIELD OF THE INVENTION

The present invention relates to a digital TV receptor system comprising a user interface for integrated access to linear multimedia content such as, for example, digital TV channels transmitted by land, satellite or cable TV broadcasters, “multi-cast” or live streams transmitted by data networks or over the Internet, as well as on demand or non-linear multimedia content, such as, for example, contents of Internet services and/or multimedia applications in a digital TV reception apparatus having support for playback of such multimedia content.

In particular, the interface according to the present invention allows the user to navigate through linear and non-linear multimedia content from multiple sources in a single list and in a transparent manner, so as to present non-linear content as if such content were also from TV channels. In this way, user access to multimedia content offered by various services and providers of Internet content is feasible.

### BACKGROUND OF THE INVENTION

A digital TV reception apparatus is a device capable of receiving and decoding digital signals sent by various TV broadcasters for presentation on a monitor. Such apparatus may be fixed (integrated to the TV set or not), portable or mobile. Currently such devices already allow the playback of non-linear multimedia content loaded from an Internet connection, but the consumption of such content is done through applications, which may be factory-installed in the digital TV reception apparatus, subsequently installed by the user or even transmitted by the digital TV signal.

In the currently available model of digital TV reception apparatuses, the user must leave the interaction environment with the traditional (linear multimedia content) TV channels and access another interaction environment to be able to access the non-linear multimedia content coming from the Internet. However, this operation tends to create a barrier to access to such non-linear content, since it favors the consumption of linear content from traditional digital TV channels while hinders the consumption of non-linear content from Internet channels.

With this problem in mind, document WO1998056188, in an attempt to resolve it, discloses a system of client and server that provides an integrated solution for TV with on demand content from the Internet. Specifically, this document describes a rotating menu that allows navigation between TV channels and Internet pages, as well as the means by which the content is downloaded to the apparatus via connection with a server. However, this system displays web pages on TV channels instead of only multimedia content, which would enable giving such content from the Internet the same aspect of content coming from the digital TV signal.

US 2012/0216228 A1 describes a method which includes offering to the user a programming guide including listings associated with a number of channels provided by a television service provider. The method described above can also include receiving, from a user, input corresponding to a request to add a listing in the programming guide associated with an online content provider, and providing a user interface with requires that the user add information associated with the online content provider. The method may further include receiving, via the user interface, an identifier associated with the online content provider, storing the identifier in a memory, and modifying the programming guide to include the listing associated with the online content provider. Clearly, the described invention aims to integrate the traditional TV contents with the internet contents, however, it still shows the disadvantage of the user needs to enter in the programming guide functionality of the Digital TV receptor to access the online contents. Again, the user needs to leave the interaction environment with the traditional TV channels (linear multimedia content) and access another interaction environment to be able to access the non-linear multimedia content coming from the internet. In addition, the invention requires that the user enter, manually, the online content provider data, making it difficult the incorporation of such contents. In addition, this document does not describes how the online content providers, which can be included in this programing guide, are found by the user.

In this sense, the present invention provides a user interface that provides navigation through linear and non-linear multimedia content from multiple sources, in the interaction environment with the traditional TV channels, in a single list and in a transparent manner, so as to present non-linear content as if such content were also from TV channels. In addition, the present invention provides mechanisms, which allow the automatic discovery of online multimedia contents.

### DESCRIPTION OF THE INVENTION

For the purposes of the present invention, in the description that will be made in the following, it should be considered that;
the expression “digital TV reception apparatus” should be understood as any device having support for running digital files capable of receiving and decoding the digital TV signals sent by ground, satellite or cable TV broadcasters for presentation on a monitor. Such apparatus may be fixed (integrated to the TV set or not), portable or mobile;
the expression “linear multimedia content” should be understood as comprising the content that its playback progresses without any intervention or control on the part of the user. Examples of linear multimedia content include, however, without limiting, the TV signal and “online” videos when played in uninterrupted manner; and
the expression “non-linear multimedia content” should be understood as comprising the content that its playback, in order to progress, requires intervention or control on the part of the user, i.e., that demands interactivity.

Examples of linear multimedia content include, without however limiting, hyperlinks, video games, online music and videos consumed on demand.

Thus, according to the present invention, it is provided a digital TV receptor system comprising an integrated user interface that allows access to linear and non-linear multimedia content from multiple sources in a single list and in a transparent manner, so as to present non-linear content as if such content were also from TV channels.

Said TV channels receive the same treatment of traditional TV channels, allowing the user to browse freely through linear and non-linear channels using the channel change keys of a conventional remote control, or the navigation arrows thereof (i.e. in the same interaction environment with traditional TV channels). In the same way, non-linear content channels can he bookmarked by user for a quicker navigation, in the same way that it is possible to be done with the traditional TV channels.

The integrated user interface in accordance with the present invention also allows the various channels of Internet content to have a standardized interface between themselves, which will provide such channels with the appearance similar to a traditional TV channel, with continuous playback of Internet videos, but also by adding features that allow the consumption of on demand content, such as, for example, the selection of categories, search by keyword and display of videos related to the current one.

The integrated user interlace is structured in such a way as to provide the functions of, at least:

a) discovering and tuning into digital TV channels, in a manual and/or automatic way, by scanning the radio-frequency spectrum for the transmission of digital TV;

b) discovering and installing channels with content from the Internet, in a manual and/or automatic way, by consulting a list of these types of channels, available from an internet server.

Additionally, the integrated user interlace is structured in such a way as to provide, in the interaction environment with traditional TV channels, the functions of, at least:

c) navigating through a single environment and/or list that aggregates digital TV channels and Internet channels using the keys “channel up” and “channel down” (or equal) on the remote control, or the navigation arrows thereof, or any other type of mechanism used for changing the channel;

d) watching content from digital TV channels in a linear manner;

e) watching content from Internet channels in a linear (continuous) manner;

f) watching content from Internet channels in a non-linear (on demand) manner;

Optionally, the integrated user interface provides functions of:

g) bookmarking digital TV channels;

h) bookmarking channels with content from the Internet;

Additionally, the integrated user interface in accordance with the present invention is structured in such a way as to provide the functions of, at least:

i) searching for contents in channels with content from the Internet;

j) filtering contents by the selection of categories in channels with content from the Internet;

k) see contents related to the video that is playing at the time in channels with content from the Internet;

l) removing digital TV channels when desired;

m) removing channels with content from the Internet when desired.

Additionally, the integrated user interface in accordance with the present invention is structured in such a way as to provide all of the above-defined functions or combinations thereof.

The present invention also provides a method for implementing the digital TV receptor system incorporated to said user interface which comprises the steps of:

(i) providing a digitally readable medium comprising lines of program code, which is stored in “read only” memory in the TV receiver and can be part of the TV receiver firmware, and
(ii) provide means for performing such lines of program code in order to implement integrated access to linear and non-linear multimedia content from multiple sources in a digital TV reception apparatus with support to the playback of such multimedia content, the means of running being present in the digital TV receiver and comprising a processor and RAM memory.

### EXAMPLE OF EMBODIMENT

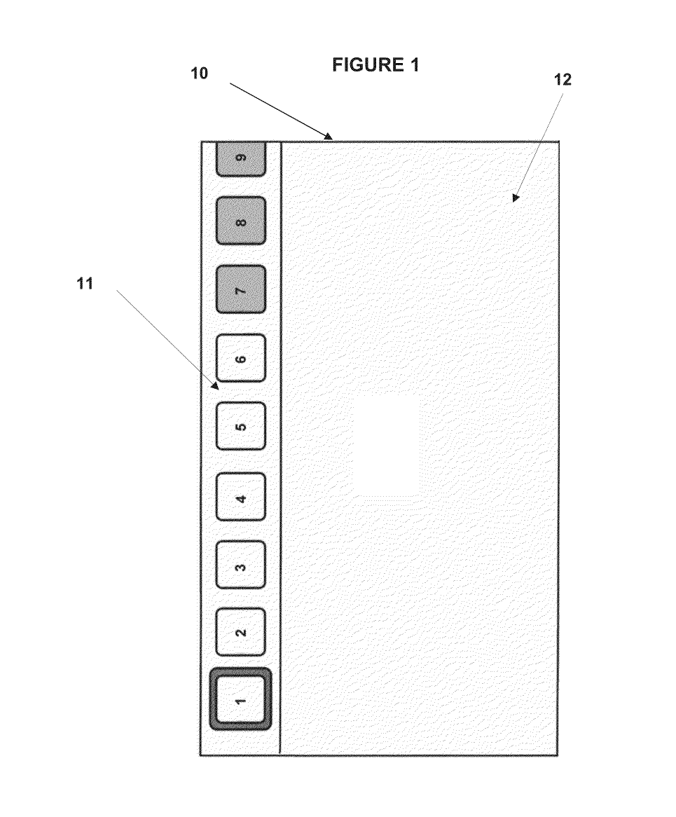

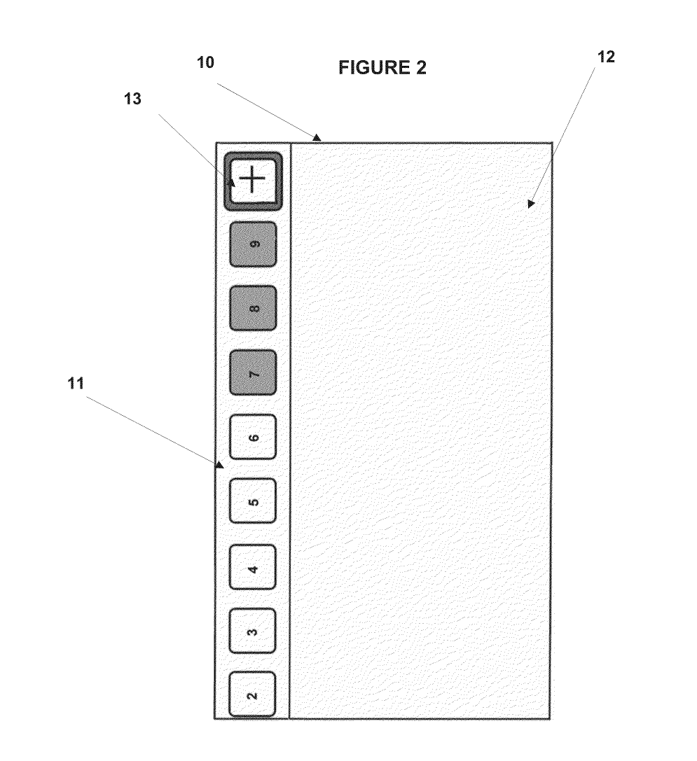

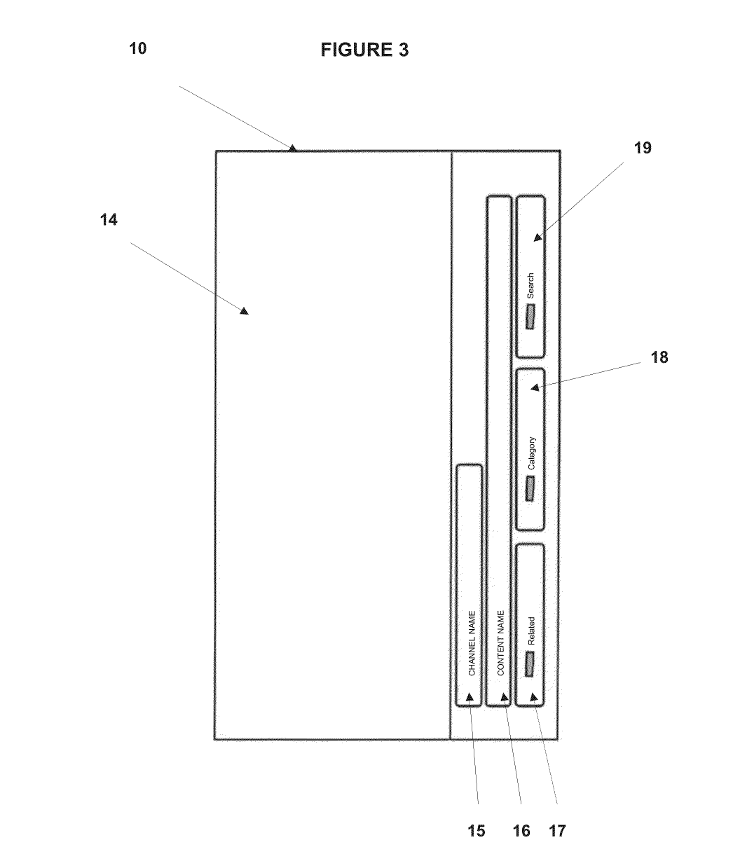

The following description will make additional reference to FIGS. 1, 2 and 3, which represent non-limiting schematic examples of the scope of the invention. Such examples represent some of the possible forms of presentation of the user interface according to the system of the present invention in a digital TV reception apparatus.

The interface that integrates linear and non-linear multimedia content from multiple sources is shipped by the manufacturer in the memory of the digital TV receiver (10), being activated by the user using the buttons on the remote control used to perform channel changing. Upon being activated, this interface in the form of a list (11) appears over a background (12) that may be, however, without limiting, the video that is being played by a channel, a static or animated image file, or a video file embedded in receiver.

The primary function of the interface in the form of a list (11) is to streamline the access to different types of available channels, either TV channels tuned from the digital air signal or Internet channels installed from an Internet connection.

The icons that selects these types of channels are viewed through the list (11), arranged on the TV screen (10) in a quick access area. First, icons are displayed which lead to the TV channels (1, 2, 3, 4, 5, 6) and then icons that lead to Internet channels (7, 8, 9). There is no maximum limit to the amount of icons of one type or the other that may be displayed in the list (11) as it is rotating, i.e., when you reach the end of the list, the next item will be the first one.

With the list (11) open, the user can change the channel using the remote control keys commonly used to perform channel changing or use the arrow keys on the remote control to move the focus of navigation through the menu up to the desired icon (1-9) and press the confirmation key “OK” on the remote control. The difference between the two types of navigation is that, when using the channel changing keys, the channel change is automatic, whereas when using the directional arrows, the channel changing occurs after the icon of a certain channel is selected during a given period of time or when you press the “OK” confirmation key on the remote control.

The last icon of this list will always be the “+Channels” (13), which calls a setup screen that allows you to tune to new TV channels or install new Internet channels. If there are no TV channels tuned or Internet channels installed, only the icon “+Channels” (13) will be displayed on the list (11).

When a TV channel icon (1-6) is selected, the channel is tuned. When pressing the “INFO” key on the remote control, information pertinent to the content are displayed, such as channel name, name of the show that is airing, age rating, synopsis, among other information.

When selecting the icon (7-9) of an Internet channel, an interface is displayed that makes the experience as closest as possible to that which the user has when watching a TV channel. The video will begin to he played in full screen (14) and, as soon as it finishes, another video is palyed subsequently and so on. When pressing the “INFO” button on the remote control, relevant information are displayed, such as name of the channel of the video that is airing in a video area (15) and content in a video area (16), the user still being able to access on demand content through the functions of access to related videos in a video area (17), selection of category in a video area (18) and search for content by keyword in a video area (19). All of these functions are accessed through the pressing of colored keys on the remote control.

As can be seen, the user interface in accordance with the system of the present invention provides, in a digital TV reception apparatus, a single list integrating linear and non-linear channels, allowing the user to quickly change between content from TV channels and from Internet channels through a simple channel changing via remote control. The tuning of linear channels available in the region in which the digital TV reception apparatus is found and the installation of new non-linear channels can be quickly accessed via the same menu.

Thus, those versed in the art will appreciate that the digital TV receptor system in accordance with the present invention provides integrated access to multimedia content from the Internet with the same user experience of the content coming from the Digital TV signal, i.e., with a seamless playback of videos in full screen from Internet content services, so as to facilitate and streamline the consumption of this content on the part of the user, giving the aspect of a linear multimedia content to a kind of content that, in other apparatuses, can only be consumed in a non-linear manner. In addition, the system in accordance with the present invention also provides, optionally, consuming on demand content from the Internet in a non-linear manner, if so desired.

1. An integrated user interface of access to linear and non-linear multimedia content originating from multiple sources, comprising a digitally readable medium comprising lines of program code, which is found stored in “read only” memory in the TV receiver and can be part of the TV receiver firmware, and means for running such lines of program code in order to implement integrated access to linear and non-linear multimedia content originating from multiple sources in a digital TV reception apparatus with support for the playback of such multimedia content, the means of running being present in the digital TV receiver and comprising a processor and RAM memory.

2. The integrated user interface of access to linear and non-linear multimedia content originating from multiple sources, according to claim 1, wherein it is structured in such a way as to provide the functions of at least: a) discovering and tuning into digital TV channels, in a manual and/or automatic way; b) discovering and installing channels with content originating from the Internet, in a manual and/or automatic way; such actions being performed in an integrated or unified manner.

3. The integrated user interface of access to linear and non-linear multimedia content originating from multiple sources, according to claim 1, wherein it is structured in such a way as to provide the functions of at least: c) navigating through a single environment and/or list that aggregates digital TV channels and Internet channels using the keys “channel up” and “channel down” on the remote control, or the navigation arrows thereof, or any other type of mechanism used for changing the channel; d) watching content from digital TV channels in a linear manner; e) watching content from Internet channels in a linear (continuous) manner; f) watching content from Internet channels in a non-linear (on demand) manner; and optionally providing the following functionalities: g) bookmarking digital TV channels; and h) bookmarking channels with content from the Internet;

4. The integrated user interface of access to linear and non-linear multimedia content originating from multiple sources, according to claim 1, wherein it is structured in such a way as to provide the functions of at least: i) searching by content in channels with content from the Internet; j) filtering content through the choice of categories in channels with content from the Internet; l) see content related to the video that is playing at the time in channels with content from the Internet; m) remove digital TV channels when desired; n) removing channels with content from the Internet when desired.

5. The integrated user interface of access to linear and non-linear multimedia content originating from multiple sources, according to claim 1, wherein it is structured in such a way as to provide the set of functions defined in claims 2-4 or combinations thereof.

6. The integrated user interface of access to linear and non-linear multimedia content originating from multiple sources, according to claim 1, wherein it is embedded in the digital TV receiver memory (10), being called by the user through the remote control keys used to perform channel switching, so as to present a list (11) on a video background (12), said list (11) displaying icons that lead to TV channels (1, 2, 3, 4, 5, 6) followed by icons that lead to Internet channels (7, 8, 9) and/or by a “+Channels” icon (13).

7. The integrated user interface of access to linear and non-linear multimedia content originating from multiple sources, according to claim 6, wherein said list (11) is of rotating type.

8. The integrated user interface of access to linear and non-linear multimedia content originating from multiple sources, according to any of claims 2-7, wherein it is operated from the remote control commonly used in digital TV reception apparatuses.

9. The integrated user interface of access to linear and non-linear multimedia content originating from multiple sources, according to claim 6, wherein, when selecting any of the icons (7-9) of an Internet channel, media is played in full screen (14), enabling the displaying of information such as the name of the channel of the video that is playing in a video area (15) and the content in a video area (16), in addition to accessing on demand content through the functions of access to related videos in a video area (17), selection of category in a video area (18) and search for content by keyword in a video area (19).

10. The integrated user interface of access to linear and non-linear multimedia content originating from multiple sources, according to claim 9, wherein said interface provides a function that allows the continuous loading of videos.

11. The integrated user interface of access to linear and non-linear multimedia content originating from multiple sources, according to any of claims 9-10, wherein it is operated from the remote control commonly used in digital TV reception apparatuses.

12. The integrated user interface of access to linear and non-linear multimedia content originating from multiple sources, according to any of previous claims, comprising the steps of:
(I) providing a digitally readable medium comprising lines of program code, which is stored in “read only” memory in the TV receiver and can be part of the TV receiver firmware, and
(II) provide means for performing such lines of program code in order to implement integrated access to linear and non-linear multimedia content originating from multiple sources in a digital TV reception apparatus with support to the playback of such multimedia content, the means of running being present in the digital TV receiver and comprising a processor and RAM memory; said means being accessed through the visual interface defined in claims 1-11.
